(19) United States
(12) Patent Application Publication
(10) Pub. No.: US 2007/0243746 A1
(43) Pub. Date: Oct. 18, 2007

(54) Socket connector

(75) Inventor: Chun-Hsiang Chiang, Taipei Hsien (TW)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/788,143

(22) Filed: Apr. 18, 2007

(30) Foreign Application Priority Data
Apr. 18, 2006 (TW) 95206554

(51) Int. Cl. H01R 13/62

(52) U.S. Cl. 439/331

(57) ABSTRACT

A socket connector that is capable of supporting and blocking a chip module therein includes an insulating body, a plurality of conductive terminals and a plate-like blocking frame. The conductive terminals are provided in the insulating body. Four sides of the plate-like blocking frame enclose to form an accommodating space. The rear portion of the plate-like blocking frame is pivotally connected to the rear portion of the insulating body. The front portion of the plate-like blocking frame is locked to the front portion of the insulating body. A piece body extends from an adjacent corner of the plate-like blocking frame. The distal end of the piece body is divided into two abutting portions. The two abutting portions are located in the accommodating space, so that the chip module can be pushed in position to obtain a good electrical connection with the socket connector.

### FIELD OF THE INVENTION

The present invention relates to a socket connector, and in particular to a socket connector for pushing a chip module supported thereon in position, thereby obtaining a good electrical connection.

### BACKGROUND OF THE INVENTION

A chip module having the standard of Land Grid Array Package, such as a central processor of a computer host, is mounted on a socket connector of a circuit board. The socket connector includes an insulating body, a plurality of conductive terminals and a locking assembly. The plurality of conductive terminals is provided in the insulating body. The insulating body supports a chip module thereon. The locking assembly presses the chip module on the insulating body. In this way, electric contacts on the bottom surface of the chip module can be brought into electrical contact with conductive terminals of the insulating body, and thus is electrically connected to the circuit board via these conductive terminals.

The top surface of the chip module is coated with a layer of adhesive heat-dissipating paste. A heat dissipator is disposed on the socket connector to contact with the heat-dissipating paste coated on the top surface of the chip module, thereby dissipating the heat generated by the chip module.

When the heat dissipator is picked up, the locking assembly blocks the chip module. In this way, the chip module can be avoided from being picked up together with the heat dissipator and can be avoided from the later falling and damage.

Taiwan Patent Publication No. M257534, published on Feb. 21, 2005, discloses a conventional socket connector, which includes an insulating base, a frame, a pressing cover and a poking rod. The insulating base is provided with a receiving portion and a mounting portion. The receiving portion accommodates the chip module therein. The side edge of the mounting portion is provided with a plurality of projecting points. The inside edge of a hollow bottom wall of the frame is provided with a plurality of troughs. The protruding points mate with the troughs, respectively, so that the insulating base is combined with the frame and the pressing cover and the poking rod are pivotally connected to two opposing ends of the frame.

When the chip module is disposed in the socket connector, the dimension of the space of the receiving portion that accommodates the chip module is slightly larger than the dimension of the chip module, so that it is easier to dispose the chip module in the socket connector. However, owing to this clearance, the chip module is movable in the socket connector and thus cannot be positioned accurately. Accordingly, the electric contacts on the bottom surface of the chip module may deviate from the conductive terminals of the insulating base easily. As a result, the chip module cannot be brought into electrical connection with the socket connector normally and thus cannot exhibit the performance thereof. According to the above, in practice, the above-mentioned socket connector really has some inconvenience and problems and thus needs to be improved.

### SUMMARY OF THE INVENTION

The primary object of the present invention is to provide a socket connector whereby a chip module supported thereon can be pushed in position to obtain a firm electrical connection between the chip module and the socket connector.

In order to achieve the above objects, the present invention provides a socket connector which includes an insulating body, a plurality of conductive terminals provided in the insulating body, and a plate-like blocking frame with four sides thereof enclosing to form an accommodating space. The rear portion of the plate-like blocking frame is pivotally connected to the rear portion of the insulating body. The front portion of the plate-like blocking frame is locked to the front portion of the insulating body. A piece body extends from an adjacent corner of the plate-like blocking frame. The end of the piece body is divided into two sections each forming an abutting portion. The two abutting portions are located in the accommodating space.

In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a perspective view showing the socket connector in accordance with the first embodiment of the present invention and a chip module;

FIG. 2 is a perspective view showing the socket connector in accordance with the first embodiment of the present invention;

FIG. 3 is a perspective view showing the socket connector in accordance with the second embodiment of the present invention; and

FIG. 4 is a perspective view showing the socket connector in accordance with the third embodiment of the present invention.

### DETAILED DESCRIPTION OF THE INVENTION

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

The socket connector of the present invention can support and block a chip module 9 therein. The chip module 9 can be a chip module having the specification of Land Grid Array Package, such as a central processor of a computer host. The chip module is provided with a printed circuit board 90 and a heat dissipator 91. The heat dissipator 91 is fixedly provided on an upper end of the printed circuit board 90, and the lower left corner thereof has a chamfer 92. The chamfer 92 acts as a fool-proofing means for indicating the corner in which a first terminal of the chip module 9 is located.

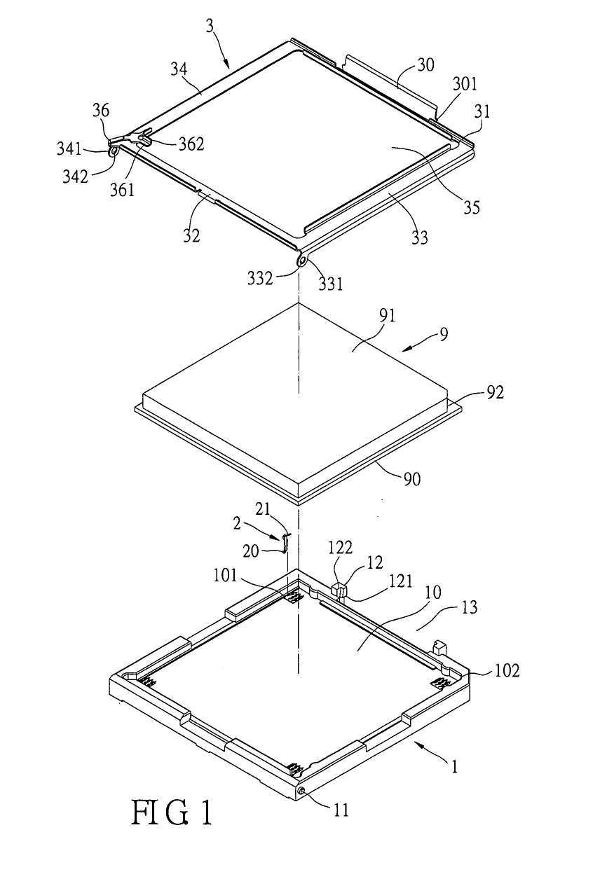

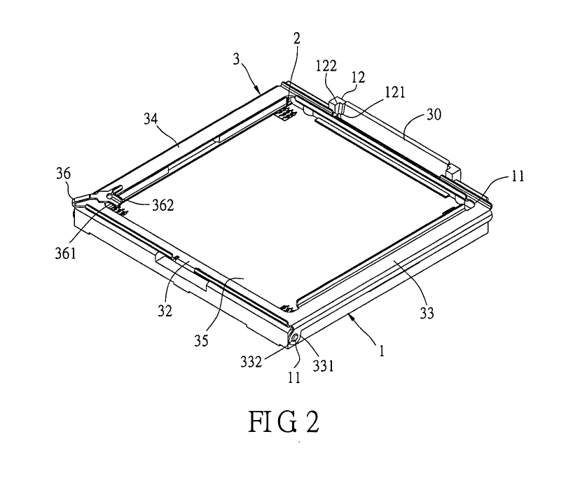

With reference to FIGS. 1 and 2, the socket connector in accordance with the first embodiment of the present invention includes an insulating body 1, a plurality of conductive terminals 2 and a plate-like blocking frame 3.

The insulating body 1 is formed into a rectangular shape. The top surface thereof is provided with a recessed mounting portion 10. The mounting portion 10 is provided with a plurality of terminal troughs 101. The lower left comer of the mounting portion 10 is provided with a chamfer 102. The chamfer 102 corresponds to the chamfer 92 of the chip module 9. Two ends of the rear portion of the insulating body 1 are each provided with a protruding shaft 11.

The front portion of the insulating body 1 is provided with a locking device. The locking device has two protruding blocks 12, two blocking portions 121 and two recessed troughs 122. The insulating body 1 is provided with a notch 13 between the protruding blocks 12. The blocking portions 121 are formed on upper edges of the opposing insides of the protruding blocks 12. The recessed troughs 122 are formed on the rear sides of the blocking portions 121.

The conductive terminals 2 are formed in the terminal troughs 101 of the mounting portion 10. Each conductive terminal 2 is a SMT terminal (Surface Mount Technology). The bottom end and the top end of each conductive terminal 2 have a welding portion 20 and a contacting portion 21, respectively. Each welding portion 20 is used to weld a solder ball onto a circuit board (not shown). Each contacting portion 21 is brought into electrical contact with the chip module 9.

The plate-like blocking frame 3 has a front blocking plate 31, a rear blocking plate 32, a left blocking plate 33 and a right blocking plate 34. The front blocking plate 31 and the rear blocking plate 32 are located in the front and rear portions of the plate-like blocking frame 3, respectively. Both ends of the left and right blocking plates 33, 34 are connected respectively to both ends of the front and rear blocking plates 31, 32. The front blocking plate 31, the rear blocking plate 32, the left blocking plate 33 and the right blocking plate 34 enclose to form a closed rectangular outer frame and an inner accommodating space 35.

A L-shaped piece body 36 extends from an adjacent corner of the plate-like blocking frame 3. The distal end of the piece body 36 is divided into two abutting portions 361. The two abutting portions 361 are located in the accommodating space 35. The two abutting portions 361 are bent upwardly to form a pushing surface 362 respectively. The two pushing surfaces 362 are generally perpendicular to each other. The extending lines of the two pushing surfaces 362 intersect with a diagonal of the accommodating space 35.

Furthermore, the rear portion of the plate-like blocking frame 3 has a left pivoting piece 331 and a right pivoting piece 341. The left pivoting piece 331 and the right pivoting piece 341 are connected respectively to the rear ends of the left and right blocking plates 33, 34. The left pivoting piece 331 and the right pivoting piece 341 are each provided with a left pivoting hole 332 and a right pivoting hole 342. The two pivoting holes 332, 342 are pivotally connected to the protruding shafts 11, so that the rear portion of the plate-like blocking frame 3 is pivotally connected to the rear portion of the insulating body 1.

The front portion of the plate-like blocking frame 3 has an elastic locking device. The elastic locking device has a U-shaped elastic arm 30. The rear end of the elastic arm 30 is connected to the front edge of the front blocking plate 31. The front end of the elastic arm 30 is a free end and has two hooks 301 that are located at both sides of the elastic arm.

When the chip module 9 is mounted to the socket connector of the present invention, the chip module 9 is disposed in the mounting portion 10 of the insulating body 1. Then, the plate-like blocking frame 3 is covered. The pushing surfaces 362 of the two abutting portions 361 are pushed to abut against the right and rear corners of the heat dissipator 91 of the chip module 9. As a result, the chip module 9 is pushed toward the chamfer 102 of the mounting portion 10 stably via the right and rear sides thereof. Accordingly, the plate-like blocking frame 3 can push the chip module 9 to abut against two adjacent sides of the lower left corner of the insulating body 1, so that the chip module 9 can be pushed in position to obtain a good electrical contact with the conductive terminals 2.

At this time, the front portion of the plate-like blocking frame 3 covers the front portion of the insulating body 1, and the free end of the elastic arm 30 is pressed to move downwardly, so that the hooks 301 pass through the recessed troughs 122 respectively. Subsequently, the free ends of elastic arm 30 are released, so that the hooks 301 of the free end of the elastic arm 30 are hooked under the blocking portions 121 of the locking device of the insulating body 1. The elastic locking device is accommodated in the notch 13, so that the elastic locking device on the front portion of the plate-like blocking frame 3 is detachably locked to the locking device on the front portion of the insulating body 1.

Therefore, via the front, rear, left and right blocking plates 31, 32, 33, 34 of the plate-like blocking frame 3, the chip module 9 is blocked on the insulating body 1. Also, the top surface of the chip module 9 corresponds to the accommodating space 35 of the plate-like blocking frame 3.

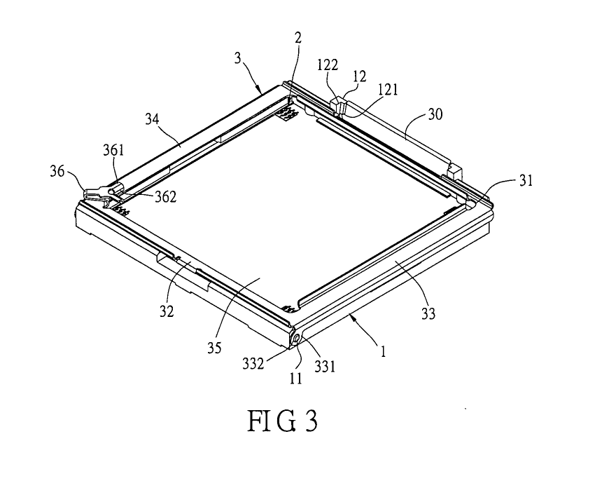

Please refer to FIG. 3, which shows the second embodiment of the socket connector of the present invention. The difference between the first embodiment and the second embodiment lies in that a S-shaped piece body 36 extends from the inside of an adjacent corner of the plate-like blocking frame 3. The distal end of the piece body 36 is divided into two abutting portions 361. The two abutting portions 361 are located in the accommodating space 35. The two abutting portions 361 are bent downwardly to form a pushing surface 362 respectively. The two pushing surfaces 362 are perpendicular to each other. The extending lines of the two pushing surfaces 362 intersect with a diagonal of the accommodating space 35.

When the plate-like blocking frame 3 covers downwardly, the pushing surfaces 362 of the two abutting portions 361 abut against the corner adjacent to the right and rear sides of the heat dissipator 91 of the chip module 9, thereby pushing the chip module 9 in position.

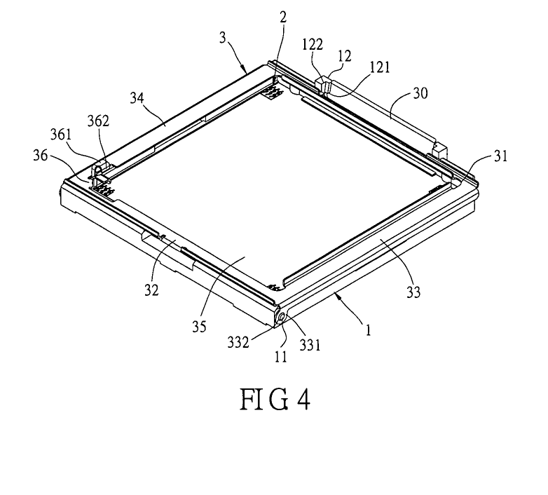

Please refer to FIG. 4, which shows the third embodiment of the socket connector of the present invention. The difference between the third embodiment and the second embodiment lies in that a piece body 36 extends from an adjacent corner of the plate-like blocking frame 3. The distal end of the piece body 36 is divided into two sections each of which is bent to form an abutting portion 361. The two abutting portions 361 are located in the accommodating space 35. The two abutting portions 361 are bent downwardly to form a pushing surface 362 respectively. The two pushing surfaces 362 are perpendicular to each other. The extending lines of the two pushing surfaces 362 intersect with a diagonal of the accommodating space 35.

When the plate-like blocking frame 3 covers downwardly, the pushing surfaces 362 of the two abutting portions 361 abut against the corner adjacent to the right and rear sides of the heat dissipator 91 of the chip module 9, thereby pushing the chip module 9 in position..

Therefore, in the socket connector of the present invention, the piece body 36 extending from the plate-like blocking frame 3 can push the chip module 9 to move toward two adjacent sides of the lower left corner of the insulating body 1 upon the insertion of the chip module 9. As a result, the chip module 9 will not be deviated from the conductive terminals 2 and thus produces a good electrical contact with the conductive terminals 2. Therefore, the chip module 9 can be electrically connected with the socket connector of the present invention firmly and thus exhibit the performance thereof.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

While a preferred embodiment of the invention is shown and described, it is envisioned that those skilled in the art may devise various modifications without departing from the spirit and scope of the foregoing description and the appended claims.

What is claimed is:

1. A socket connector, comprising:
an insulating body;
a plurality of conductive terminals provided in the insulating body; and
a plate-like blocking frame, four sides thereof enclosing to form an accommodating space, the rear portion of the plate-like blocking frame being pivotally connected to the rear portion of the insulating body, the front portion of the plate-like blocking frame being locked to the front portion of the insulating body, a piece body being formed by means of extending from an adjacent corner of the plate-like blocking frame, the distal end of the piece body being divided into two sections each forming an abutting portion, the two abutting portions being located in the accommodating space.

2. The socket connector according to claim 1, wherein the front portion of the insulating body is provided with a locking device, the front portion of the plate-like blocking frame has an elastic locking device, and the elastic locking device is detachably locked to the locking device.

3. The socket connector according to claim 1, wherein the two abutting portions each has a pushing surface, and the two pushing surfaces are perpendicular to each other.

4. The socket connector according to claim 1, wherein the extending lines of the two pushing surfaces intersect with a diagonal of the accommodating space.

5. The socket connector according to claim 1, wherein the two abutting portions are generally perpendicular to each other.

6. The socket connector according to claim 3, wherein the pushing surfaces extend away from the accommodating space.

7. The socket connector according to claim 3, wherein the pushing surfaces extend toward the accommodating space.
